(19) United States
(12) Patent Application Publication
(10) Pub. No.: US 2012/0313948 A1
(43) Pub. Date: Dec. 13, 2012

(54) Method and System for Providing Community Networking Services in an Organization

(76) Inventors: Ruth Bergman, Haifa (IL); Michael Aharon, Haifa (IL); Kas Kasravi, W. Bloomfield, MI (US)

(21) Appl. No.: 13/288,488

(22) Filed: Nov. 3, 2011

Related U.S. Application Data
(60) Provisional application No. 61/494,239, filed on Jun. 7, 2011.

(51) Int. Cl. G06T 11/20

(52) U.S. Cl. 345/440

(57) ABSTRACT

A method of providing community networking services in an organization creates a graph which has a plurality of people nodes representing persons in the organization and a plurality of content nodes representing content objects authored by the persons. The nodes are connected by edges, which include author edges linking the content objects to the persons and similarity edges each linking two content objects and having a similarity value indicative of a conceptual similarity between said two content objects. The graph is analyzed to compute a relevance value between a focus node and a query node in the graph.

### RELATED APPLICATION

This application claims the priority or U.S. Provisional Application 61/494,239, filed Jun. 7, 2011.

### BACKGROUND

According to Metcalfe's Law, the value of a network grows exponentially with the number of the nodes in the network. This premise holds true for people networks as well as digital networks. Also, Reed's law suggests that communities are composed of all the permutations of groups that can be formed within the overall population. Extracting the network value, however, can be a significant challenge. For instance, in an organization such as a medium or large corporation, much of the knowledge of the organization may be held by individuals, who may be considered subject matter experts (SMEs). When members of an organization need to solve a problem, they seek out SMEs, typically relying on their own personal networks, or extending to their associates networks. It is often the case that there is a relevant SME with the necessary knowledge, but that expert is outside the set of personal contacts reachable by the person seeking the knowledge. The knowledge or expertise of the SME is, therefore, not leveraged, and the optimal solution is either not achieved, or achieved at a greater cost and time. Also, as technologies develop and become more complex, solving a problem often requires the involvement of multiple experts from different disciplines. This requirement is often hindered by the typical organizational hierarchies, limiting the contacts among the right people, who might not even know each other's existence. Additionally, the faster pace of business and global competition requires faster development of solutions, further underscoring the need for quickly connecting the right people to address an opportunity.

### BRIEF DESCRIPTION OF THE DRAWINGS

FIG. 1 is a block diagram showing two aspects of a framework for constructing a community network based on intellectual capital of an organization in accordance with an embodiment of the invention;

FIG. 2 is a schematic diagram showing examples of nodes and edges in an intellectual capital graph for building a community network in an embodiment of the invention;

FIG. 3 is a flowchart showing steps of building an intellectual capital graph in an embodiment of the invention;

FIG. 4 is a schematic diagram illustrating an approach of extracting concepts from digital documents in an embodiment of the invention;

FIG. 5 is an example of an intellectual capital graph for illustrating an interest flow analysis applied to an intellectual capital graph for connecting people with similar interests or expertise;

FIG. 6 is an example of an intellectual capital graph for illustrating an interest flow analysis for associating people with topics or fields or expertise;

FIG. 7 is an example of a user interface screen in an embodiment of the invention for displaying how people in an organization can be connected via content objects they author; and

FIG. 8 is a computer system in an embodiment for implementing the framework for building a community network in an organization based on the intellectual capital of the organization.

### DETAILED DESCRIPTION

In embodiments of the invention described below, a framework for developing and exploring a community network based on intellectual capital is provided. The network development framework is especially useful for connecting people in an organization based on the digital content objects they have generated. The framework includes an analytic approach for identifying related content objects and connecting people with similar interests or expertise via the connections between the content objects authored by the people. Content objects, as a form of digital assets of the organization in which the community network is to be built, may be in various forms. For instance, content objects may include white papers, patents, invention disclosures, technical reports, emails, etc. In some embodiments, concepts representing fields of expertise or interests may be automatically inferred from the content objects. The premise is that people implicitly report on their expertise or interests in the documents they create and in their communications. In this regard, the frequency of such references to the concepts pertaining to the expertise or interests may be reliably used to indicate how strongly the individuals are associated with the concepts.

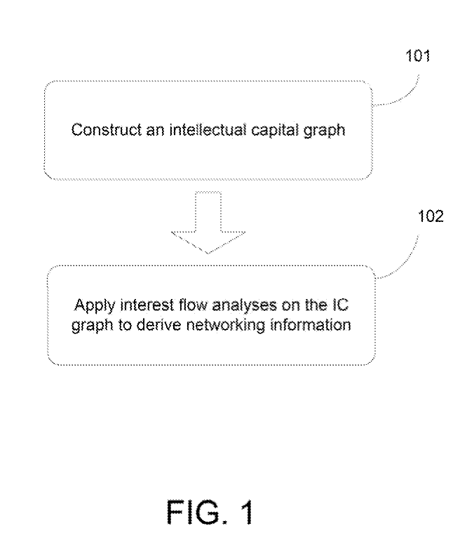

Referring now to FIG. 1, the approach of building a community network based on intellectual capital comprises two aspects. The first aspect 101 involves the construction of a graph that embodies the intellectual capital of the organization. Such a graph is referred to hereinafter as the “intellectual capital graph” or “IC graph.” Once the intellectual capital graph is constructed, the second aspect 102 of the approach is to apply analytical methods based on network flow to the graph to analyze the community network and to provide various functions for users to explore and view the community network information. In this regard, The IC graph is an effective way to represent the intellectual capital of an organization, such as a corporation. In some embodiments, the intellectual capital may be captured by the graph by including in the graph information regarding people in the organization and content objects authored by the people.

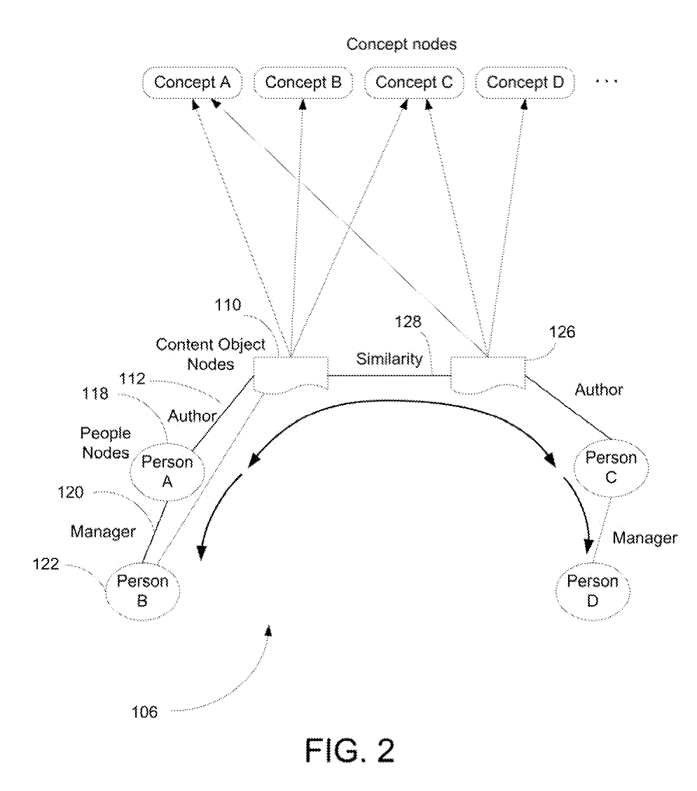

Turning now to FIG. 2, an IC graph 106 may include various types of nodes representing different components or elements related to the intellectual capital. The links between the nodes, called “edges.” define how the nodes are connected, and provide further information on how the nodes are related across the graph. The particular types of nodes and edges in the graph depend on the implementation of the invention. For instance, the IC graph 106 may include people nodes each representing a person in the organization, and a content node for every document, presentation, email, chat, etc. In addition, there may be nodes for other information such as topics, locations, events, and more. Analytics on the graph are dependent on the connectivity of the graph. Thus, the more data that can be converted into links in the graph, the higher the potential is for delivering value to the users of the community networking tools.

By way of example. FIG. 2 shows a portion of an intellectual capital graph 106 built using three types of nodes: people, content objects, and concepts. A content object 110 may represent a digital document in the form of an article, a conference paper, an email, etc. Each content object 110 may be linked by an “Author” edge 112 to a people node 118 representing a person who authored the content object. In this regard, a content object may be coauthored by multiple persons, and each of them may be linked to the content object. There may also be other types of edges linking a content object and a person. For instance, a “Received” edge may indicate that the person is a recipient of the content object. The graph may also include organizational information. For instance, a person and her manager may be connected by a “Manager” edge 120. For instance, person A, who is represented by the node 118, may be the managed by person B represented by the node 122. At the same time, person A and person B may be coauthors of the content object node 110. In this way, the IC graph not only identities the association of the content objects with the people, but also the organizational relations among the people. Among the content objects, two content objects 110 may be connected by a “similarity” edge 128, which is weighted to indicate a degree of similarity between the two content objects. As described in greater detail below, by forming the connections among the content objects, individuals may be connected through the contents objects they or their reports authored to build a social network that identifies the relatedness based on common interests or expertise.

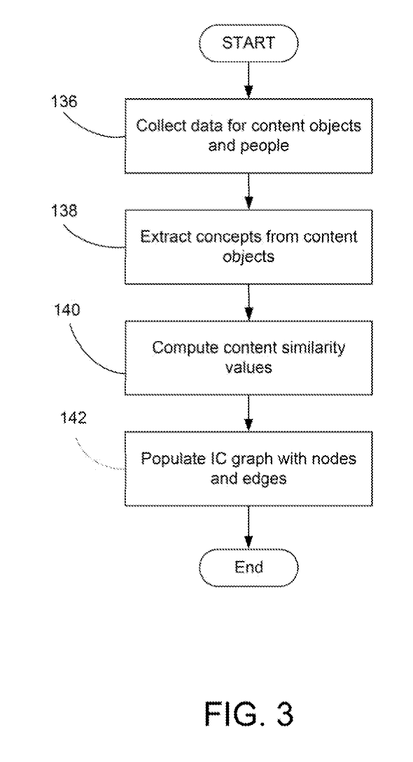

FIG. 3 shows steps of a method in an embodiment for constructing an IC graph. First, information regarding the digital contents of the organization and the people are collected and analyzed, and person nodes and content object nodes are created for the graph (step 136). Data describing the nodes may be saved as data objects, and contents represented by the nodes may be saved in a database. The content objects are then analyzed to evaluate the similarity between each two content objects. This similarity evaluation may employ linguistic and semantic analyses. As part of the similarity evaluation, a set of concepts pertinent to the contents of the content objects may be extracted (step 138). The concepts may be used to indicate the expertise or interests of a person. The similarity values among the content objects are then calculated (step 140). Besides the similarity values for the similarity edges connecting the content objects, the other nodes in the graph and the edges connecting the graph may also be assigned weights that will be used in building the community network. The IC graph is then populated with the nodes, the edges, and their respective weights (step 142).

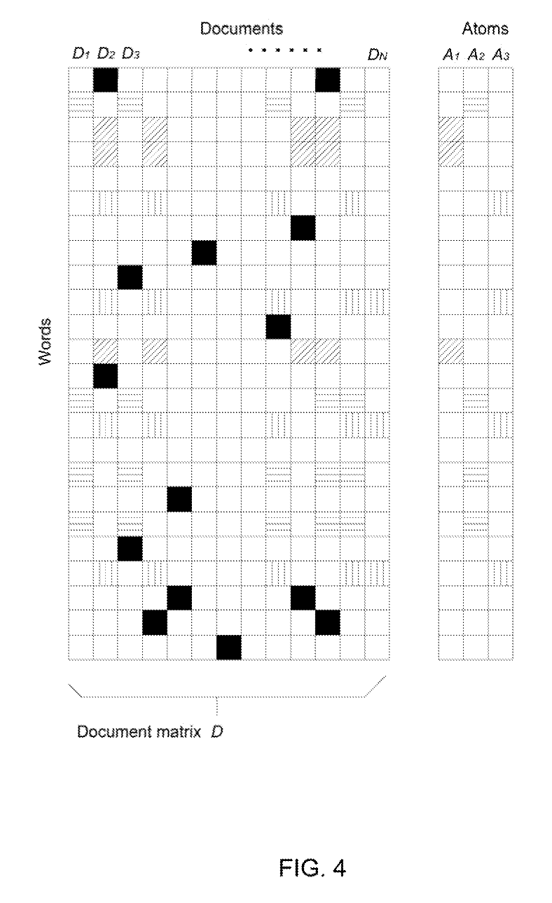

There are various ways for evaluating the similarities among digital documents within a corpus. Based on a taxonomy, which can be manually constructed or automatically derived from the documents, each document can be fully or partially associated with various concepts. One document similarity assessment method is the Vector Space Model (VSM). Under VSM, each document is represented as a vector in the space of all available words. The ith entry holds the number of times the ith word appears in the document. All the document vector's form a document matrix D (see FIG. 4). In a binary version of the model, the ith entry of the document vector simply indicates whether the ith word appears in the document or not. The similarity between two documents represented by vectors a and h is measured as the cosine distance between the vectors:

$$D ( a , b ) = \frac{{a}^{′} \cdot b}{\vert a \vert \cdot \vert b \vert}$$

Another similarity evaluation method, which is a modification of the VSM method, is Latent Semantic Indexing (LSI) or Latent Semantic Analysis (LSA). LSA computes the singular vectors that correspond to the largest singular values of the matrix that includes all documents represented as columns using VSM. Then, a new representation of a document is formed by calculating its projections onto those first singular vectors. The similarity between two documents is defined as the cosine distance between the two document vectors represented as projections onto the first singular vectors.

Another embodiment of the invention utilizes a document similarity method that leverages the idea of LSI, and enhances it with semantic topics computed by a Principal Atoms Recognition In Sets (PARIS) approach. The PARIS approach handles words as sets. Given a large number of sets, PARIS detects principal sets of elements that tend to frequently appear together in the data. The PARIS approach allows non-exact repetitions of the detected patterns in the data, and allows additional elements in the input sets that are not covered by any of the detected sets. Applying PARIS to the documents in the corpus results in sets of words that tend to appear together in many documents. These sets of words could be used to represent “concepts” discussed in the documents in the given corpus.

For the similarity calculation, the corpus of documents is represented as a binary matrix D, such that each document appears as a column {Dᵢ}ᵢ₌ⁿ. An entry Dᵢ(j) equals 1 if the word j appears in the document i. As in LSI, the first M singular vectors of this matrix, corresponding the largest singular values, are computed and denoted by {Lₘ}ₘ₌^{M}. A representation of the ith document over the singular vectors Pᵢ is computed by projecting the relevant column on those singular vectors, resulting in M coefficients. Pᵢ(m). In addition, the PARIS analysis is applied on the representing matrix D, which results into sets of words {Ai}ᵢ₌₁^{K} that frequently appear together. Each such set of words Ai is referred to as an atom, where Ai(j)=1 if the jth word is included in the ith atom. For illustration, FIG. 4 shows a document matrix D, and a plurality of atoms (A₁, A₂, A₃) derived from the documents. Each atom is represented as a word vector. These atoms may represent concepts in the document corpus. The number of atoms, designated K, is discovered automatically by the PARIS analysis module according to the input document data and its parameters. Here, the assumption is that if two documents share words from the same atom, they are similar because they probably discuss the same concept, even if not using the same words. In this regard, each atom (i.e., set of words) may be manually assigned a topic title (or concept name), for ease of reference when the atoms are used to indicate fields of expertise or topics of interest.

In one embodiment, document similarity is computed as the cosine distance between the vectors that represent the documents over the latent concepts and the atoms. Specifically, first, the average support of each atom AS over the whole corpus is computed by

$$AS \text{\textbar} ( k ) = \frac{1}{N} \cdot {\sum }_{i = 1}^{N} {( \frac{{D}_{i}^{T} \cdot {A}_{k}}{{‖ {A}_{k} ‖}_{1}} )}^{τ}$$

An element AS(j) is the average over all documents in the corpus of the ratio of words from the jth atom that appear in the documents, raised to the power of τ. The relative atoms' frequency of the ith document, RFᵢ, is defined as the relative support of all atoms in the ith document, computed by

$${RF}_{i} ( j ) = \text{\textbar} {( \frac{{D}_{i}^{T} \cdot {A}_{j}}{{‖ {A}_{j} ‖}_{1}} )}^{τ} / AS ( j ) .$$

A representation of each document in the corpus is defined by Rᵢ=[Pᵢ, ρ.RFᵢ], where P, is the LSI projection, and ρ is the constant that specifies the weight ratio between the LSI coefficients and the PARIS support. The similarity between documents i and j in the corpus is then computed as the cosine distance between the two representations,

$$S ( i , j ) = \frac{{R}_{i}^{T} \cdot {R}_{j}}{‖ {R}_{i} ‖ \cdot ‖ {R}_{j} ‖} .$$

The similarity computation may be updated whenever the document corpus evolves so as to take into account the new items. It should be noted that the similarity computation described above is only one approach to evaluating the similarity (or relevance) between two documents in a give corpus, and the invention may be implemented using other methods of similarity computation to link content objects in the intellectual capital graph.

Once the IC graph is constructed, information regarding social networking inside the organization can be derived using the graph. Interests can be inferred through content objects produced by the individuals. People are related to other people and/or concepts via paths on the IC graph that go through the content objects. In other words, people are connected to each other and to concepts by means of the content objects they created, and one person is related to another if they create similar contents.

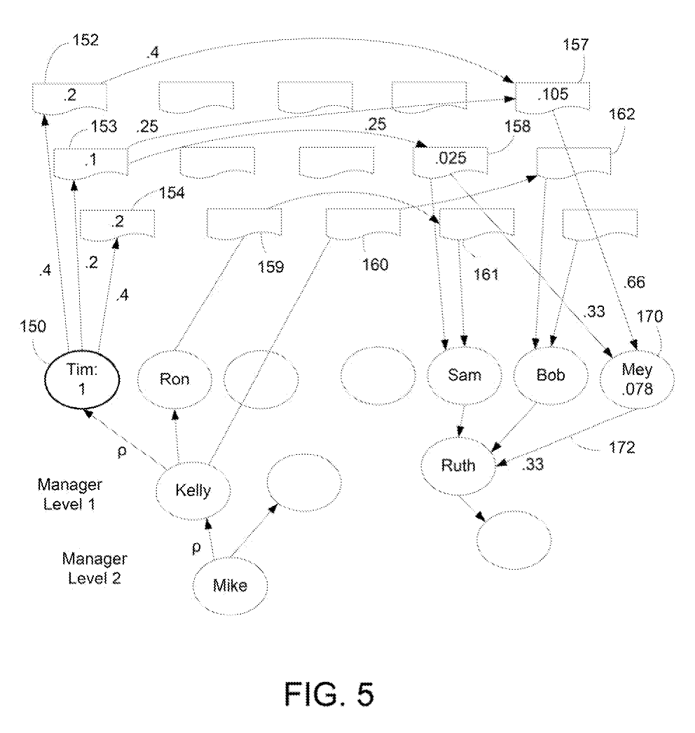

In some embodiments of the invention, an interest flow analysis is applied to the IC graph to answer networking questions or queries related to the intellectual capital of the organization. For example, the networking questions may be: “Who is relevant to me in terms of common interests or expertise?”, “Who are the experts on the topics represented by documents X, Y, and Z?”, etc. The interest flow computation starts from a “focus node” or a set of “focus nodes,” and propagates along a path or paths to a “query node.” By way of illustration. FIG. 5 shows examples of how a person may be connected to other persons in an organization. In the IC graph in FIG. 5, for clarity of illustration, only two types of nodes are shown: people and content objects. The people nodes are divided into multiple levels corresponding to the management hierarchy. In one example, the focus node 150 is for a person named Tim. On the left portion of FIG. 5, the flow starts from Tim, who has authored three documents, represented by content nodes 152, 153, 154. Based on the similarity evaluation described above, these documents are found most similar to two other documents 157 and 158. The document for node 157 is authored by Mey, and the document for node 158 is coauthored by Mey and Sam. Accordingly, Sam and Mey may be considered relevant to Tim. As another example, a flow can start from Kelly in the left part of FIG. 5. Kelly has authored one document 159 herself. Kelly manages Ron, who has authored another document 160. These two documents are found to be most similar to two other documents 161, 162, which are authored by Sam and Bob, who work in Ruth's team. Thus, Ruth may be considered relevant to Kelly, if the computed relevance value is sufficiently high.

As mentioned above, each node or each edge may be assigned a certain weight, and the interest flow from one node to others can take into account the weights. The functional dependence on the weight of each edge or node passed in the interest flow process can be selected depending on the type of edge or node, and may be adjusted based on the data being analyzed. For instance, when the interest flows through an edge, the weight of the edge may function as a simple multiplier to the interest flow. Alternatively, as an example, the edge weight to the Nth power may be used as a multiplier. This tends to have the effect of magnifying the differences in the weights of edges, and may be useful for differentiating the edge connections when their weights are similar. Other types of functional dependence may be chosen based on the nature of the edge and other factors.

For example, in the graph of FIG. 5, a factor ρ may be assigned to the interest flow from an employee to his/her manager. A similar factor can be defined for the opposite direction, i.e., the interest flow from a manager to his/her report. Each content object can have a score assigned to it to indicate its importance to the organization. For instance, papers and technical reports may be given more importance than emails, which may be more important than chats, and published papers may be given more weight than non-published drafts, etc. Also, the importance of each content object can be assigned based on other factors, such as the age of the object. For example, a multiplier inversely proportional to the age may be used in assigning weights to content objects.

To illustrate how the interest flow process is used to compute relevancy between two people, a simple numerical example is provided below with reference to FIG. 5. To find people relevant to Tim, the analysis starts with the focus node 150 representing Tim. An interest value of 1 is assigned to Tim. This interest is propagated through author edges towards the content nodes authored by Tim, through the similarity edges to other content objects, and then through author edges to other people nodes, which in this context are the “query nodes.” For simplicity and clarity of illustration, in this example each content object nodes is assigned a weight of 0.5. Tim has authored three content objects 152, 153, 154, and the three author edges to them are assigned the weights of 0.4, 0.2, and 0.4, respectively. The interest reaching each content node is multiplied the weight of the author edge and the importance weight of the content object, resulting in the interest values of 0.2, 0.1, and 0.2, respectively.

The interest then flows from each of these content nodes to other content nodes through the similarity edges. In this example, the content node 152 is connected to the content node 157 by a similarity edge with a weight of 0.4, and the content node 153 is connected to the content node 157 by a similarity edge with a weight of 0.25. The interest flowing from Tim to the content node 157 is 0.2*0.4+0.1*0.25=0.105. The content node 153 is also connected to the content node 162 via a similarity edge with a weight of 0.125, so the interest reaching the content node 158 is 0.2*0.125=0.025. Both the content objects 157, 158 are authored by Mey, and are connected to the people node 170 for Mey by author edges with weights of 0.66 and 0.33, respectively. The total interest that has flowed from Tim to Mey is then 0.105*0.66+0.025*0.33=0.078. Thus, the relevance of the Mey to Tim is indicated by the value 0.078. This interest can further flow from Mey to his manager Ruth via the manager edge 172, which has a weight of 0.33 (1 divided by the three individuals reporting to Ruth). As a result, the interest flow from Tim via Mey to Ruth is 0.078*0.33=0.026.

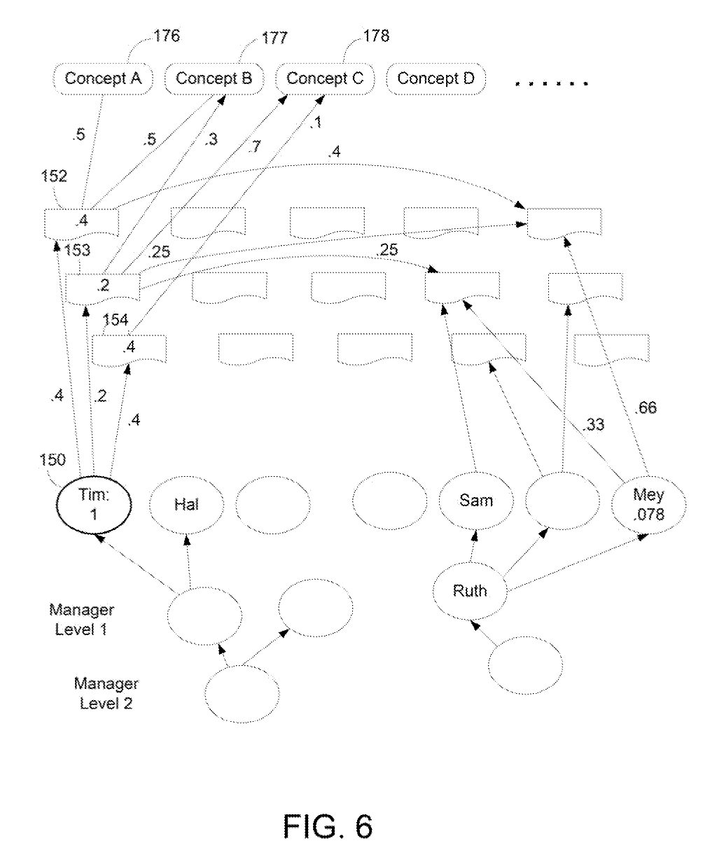

FIG. 6 provides another example, which illustrates how individual contributors are connected to concepts contained in the content objects. Such connections indicate the expertise or interests of each individual. In contrast with FIG. 5, the IC graph in FIG. 6 includes nodes representing concepts. Each content object may be connected to one or more concept nodes. The edges connecting a content object to a concept is assigned a weight, based on the relevance of the content to the concept, which may be computed using the concept extraction methods described above. In this example, the three content objects 152, 153, 154 authored by Tim are linked to the concept objects 176, 177, 178 representing concepts A, B, C via weighted edges. Again, the process starts with Tim as the focus node 150, with an interest value of 1. The interest flows to the three content objects 152, 153, 154 authored by Tim, and then to the concepts 176, 177, 178 via the concept edges. The interest reaching the concept object 177 (a query node in this analysis) representing concept B is the sum of the interest flowed from the content objects, and is calculated to be 04*0.5+0.2*0.3=0.26. This number is an indication of the Tim's expertise or interest in that concept or topic. Once the interest values flown from the individual persons in the organization to the various concepts are calculated, an automated tool is able to identify and rank relevant experts in specific topics. Thus, for example, given a request-for-proposals (RFP), the tool can match the required expertise with the right SMEs to respond to the EFP. Similarly, if a client is expected to visit, the tool can be used to recommend, from a short description of the purpose of the visit, the right SMEs who should meet with client.

The interest flow analysis on the IC graph can be the foundation of many different types of social networking tools can be provided. For instance, a tool may be provided to suggest a list of people in the organization that a focus person may be interested in talking to or collaborating. This list may be compiled, for example, by applying the interest flow analysis to compute values of relevancy of other people to the focus person. A selected number (e.g., 10) of people with the highest relevancy scores may be identified, and a filter may be applied so that people that the focus person already knows well, such as the coauthors, manager, and direct reports of the focus person, are not included in the list. This list of people of comment interests or expertise may then be presented to the focus person. In this regard, graphical user interface applications may be employed to assist the user to visualize the networking information and to further explore the network.

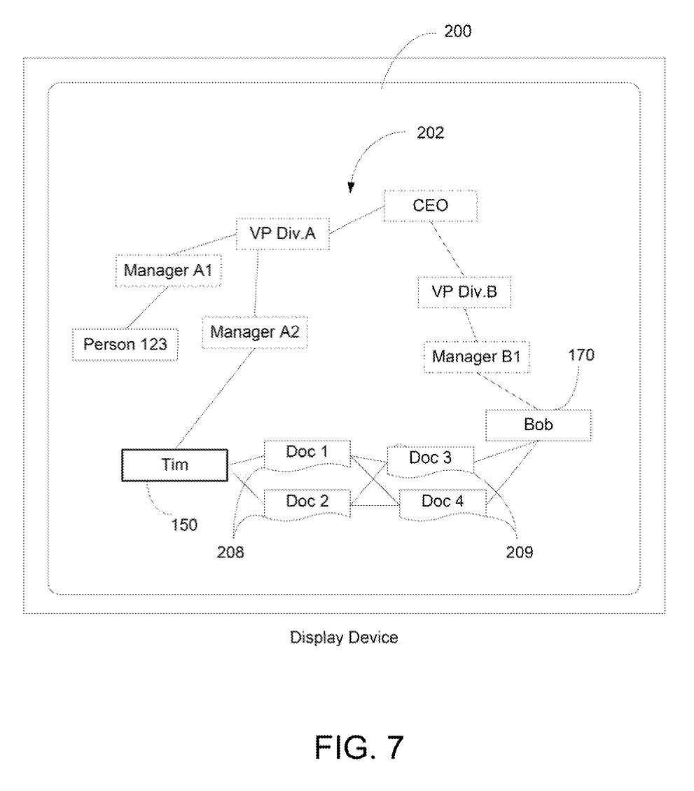

For example, FIG. 7 shows a user interface screen 200 displayed by an embodiment of the networking tool. The user interface screen shows a path 202 linking the persons most relevant to the focus person Tim as a people node 150, and includes information on why they are deemed relevant and how they are connected in terms of the organizational structure. As shown in FIG. 7, the user interface screen 200 displays elements from the IC graph, include people and content objects. Besides the people deemed relevant to the focus person, the screen also shows the hierarchical structure information for those persons, including their managers all the way up to the CEO of the organization. In this way, the viewer can easily identify the divisions in which those people of reside. Moreover, the content objects 208, 209 that connect the focus person Tim to a person of relevance, such as Bob represented by the people node 170, can be selectively displayed, so that viewer can see why the person of relevance is selected and what kind of expertise or interests they share. Thus, this user interface tool allows the user to explore the relevancy network and presents the paths that contribute the most to the relevancy score between a query node and the focus node.

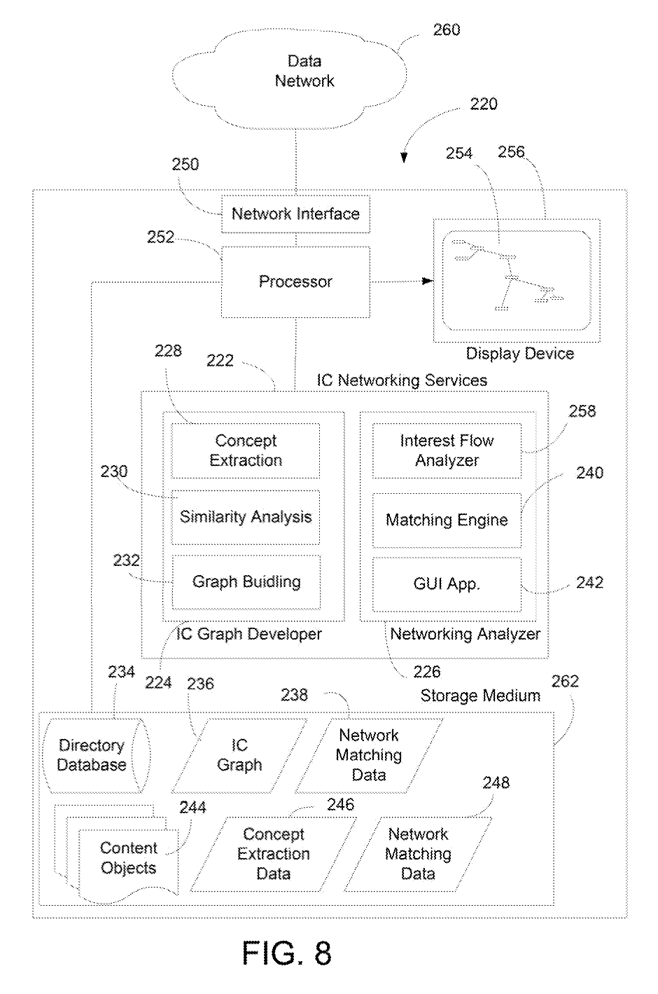

In one embodiment, a tool (e.g., the matching engine 240 in FIG. 8) is provided to generate a list of suggested attendee introductions for a person attending an event, such as a technology conference. This functionality can enhance the experience of attending the conference and create opportunities for a conference attendee to meeting new people who share similar interests or expertise. The tool generates a list of a selected number K (e.g., 5) of desirable introductions for each attendee. One requirement that may be imposed for this list is that all suggestions are symmetric. This means that if A is suggested to meet B, then B is suggested to meet A as well. In addition, filters may be applied so that the suggested introductions are likely people with whom the attendee does not already have close interactions. For instance, co-authors and people with the same second-level managers may not be suggested to each other, as they probably know each other already. If desired, some other factors, such as the numbers of email communications between the two persons, can also be used to establish familiarity for filtering purposes.

To compile such a list, the tool first computes the interest score I⁰ between each two conference attendees, as described above. Next, the tool sets to zero the interest values between people with the same second-level manager and between coauthors. The interest score between persons x and y is then turned into a symmetric score by defining I(x,y)=I⁰(x,y)+I⁰(y,x). Doing so implies that the organization will benefit from introducing between two persons x and y the sum of interests that flow from x to y and from y to x. The interest matrix I for the conference attendees is now a symmetric N×N matrix representing a clique graph with weighted edges, where the edge between people nodes i and j reflects the “potential benefit” for the organization from introducing these two persons. The tool than generates the suggested attendee introductions list using the interest matrix. This is done by detecting a sub-graph that consists of all nodes in which each node has an out degree of K, that results in the maximal benefit for the organization. The individual list of K suggested introductions for each conference attendee can be sent, for example, by email to that attendee prior to the conference, so that the attendee can contact the people on the list and make plans to meet them at the conference. It should be noted that this approach of suggesting pairwise introductions is not limited to meeting people at conferences and can be applied to various contexts involving social gatherings. For example, it can be used for dinner placement, grouping for crowdsourcing, etc.

FIG. 8 shows a computer system for implementing the community networking framework based on intellectual capital as described above. The system 220 includes a data storage medium 262 which may be used to store digital assets in the form of content objects 244 authored by persons in an organization. The system 220 includes an IC networking services module 222 for building a community network based on intellectual capital of the organization and using the network to answer intellectual capital queries. The IC networking services module 222 includes two main components: an IC graph developer 224 and a networking analyzer 226. The IC graph developer 224 is programmed to construct an IC graph based a corpus of content objects, which may be stored in the storage medium 262. To that end, the IC graph developer 224 includes a linguistic/semantic extraction engine 228 for extracting concepts associated with the content objects. A similarity analysis engine 230 in the IC graph developer 224 computes the similarity scores among the content objects. The similarity scores may be stored in the storage medium 262. Alternatively, the similarity scores may be computed on the fly. A graph building engine 232 in the IC graph developer 224 constructs the IC graph to include various nodes, which may include people nodes, content object nodes and concept nodes, and edges connecting the nodes. A directory database 234 is used as a source for information on people in the organization and the organizational hierarchy among the people. The resultant IC graph 236 may be stored in the storage medium 262 in a chosen data structure.

The networking analyzer 226 provides various functions to allow a user to explore the IC graph 236 to derive various types of networking information, such as people of relevancy, suggested attendee introductions, and people with a particular type of expertise, as described above. To that end, the networking analyzer 226 includes network analytics tools to generate the desired networking information by analyzing the IC graph. For instance, the networking analyzer 226 includes an interest flow analyzer 258 for applying interest flow analyses to the IC graph. The networking analyzer 226 also includes a matching engine 240 for grouping persons with similar expertise, identifying people with similar expertise to a locus person, and finding a network of related experts, etc. The networking analyzer 226 further includes graphic user interface tools 242 for providing graphic representations 254 of the networking information on a display device 256 for viewing by a user.

The IC networking services module 222 can be implemented as machine-readable instructions stored on a storage medium and executable on a processor 252. The processor 252 is connected to the storage medium 262 and to a network interface 250. The storage medium 262 can be implemented as one or more computer-readable or machine-readable storage devices, including DRAMS, SRAMS, flash drives, hard drives, optical storage devices, etc. The computer-executable instructions of the IC networking services module 222 may be stored in the storage medium 262, or on a separate storage medium that is non-transitory. The storage medium 262 may be used to store the input data for the IC networking services module 222, such as the content objects and directory information, as well as the output data of the IC networking services module, such as the IC graph, the networking information generated by the networking service tools, and the visual display data for display by the display device. Alternatively, the input and output data of the IC networking services module 222 may be received from and transmitted to a data network 260, such as the intranet of an organization or the internet, or a combination thereof.

As described above, a networking framework based on intellectual capital is provided to enable people to find and interact with other people in an organization based on expertise and common interests. Besides the multiple social networking scenarios described above, the expertise identification and inter-person relevancy evaluation capabilities can be useful in many other situations, such as forming optimal teams for complex crowd sourcing problems, forming teams to review inventions and attend invention workshops, identifying mentors for human resource purposes, etc. The possible ways of benefiting from this intellectual capital networking approach are too many to enumerate here.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of providing community networking services in an organization, comprising:
creating, by a system having a processor, a graph having a plurality of people nodes representing persons in the organization and a plurality of content nodes representing content objects authored by the persons, the graph further having a plurality of edges, including author edges linking the content objects to the persons and similarity edges each linking two content objects and having a similarity value indicative of a conceptual similarity between said two content objects; and
computing, by the system, a relevance value between a focus node in the graph and a query node in the graph.

2. A method as in claim 1, where the step of computing the relevance value includes applying an interest flow analysis along a path in the graph connecting the focus node to the query node.

3. A method as in claim 2, wherein the focus node is a first people node representing a first person, and the query node is a second people node representing a second person, wherein the system computes the relevance value by means of calculating an interest flow from the first person to the second person along a path in the graph including at least a first content object authored by the first person, a second content object authored by the second person, and a similarity edge linking the first and second content objects.

4. A method as in claim 2, wherein the step of generating the graph includes assigning weights to nodes and edges in the graph for calculating interest flow along the path.

5. A method as in claim 1, further including the step of computing, by the system, similarity values for similarity edges linking the Content objects.

6. A method as in claim 5, wherein the step of computing similarity values including extracting concepts from the content objects.

7. A method as in claim 6, wherein the concepts correspond to word atoms extracted from the content objects.

8. A method as in claim 1, wherein the graph further includes concept nodes representing concepts in the content objects.

9. A method as in claim 8, wherein the focus node is a person, and the query node is a concept.

10. A method as in claim 1, wherein the focus node is a focus person, and the method further comprises the step of identifying, by the system using the graph, a suggested introductions list identifying a selected number of persons based on their relevance values to the focus person.

11. A method as in claim 10, further including the step of displaying, by the system on a display device, a user interlace screen showing a path connecting the focus node to the query node.

12. A method as in claim 1, wherein the graph includes at least one manager edge connection a first people node representing a first person to a second people node representing a manager of the first person.

13. A non-transitory computer readable medium storing computer-executable instructions that upon execution cause a system to perform steps of:
creating data objects representing nodes and edges of a graph, the nodes including a plurality of people nodes representing persons in an organization and a plurality of content nodes representing content objects authored by the persons, the edges including author edges linking the content objects to the persons and similarity edges each linking two content objects and having a similarity value indicative of a similarity between said two content objects;
applying an interest flow analysis along a path in the graph connecting a focus node and a query node to compute a relevance value indicting relevance of the query node to the focus node.

14. A non-transitory computer readable medium as in claim 13, wherein the focus node is a first people node representing a first person, and the query node is a second people node representing a second person, wherein the computer-executable instructions when executed apply the interest flow analysis along a path in the graph including at least a first content object authored by the first person, a second content object authored by the second person, and a similarity edge linking the first and second content objects.

15. A non-transitory computer readable medium as in claim 13, wherein the computer-executable instructions further cause the system to compute similarity values for similarity edges linking the content objects.

16. A non-transitory computer readable medium as in claim 13, wherein the computer-executable instructions further cause the system to display a user interface screen showing the path connecting the focus node and the query node.

17. A non-transitory computer readable medium as in claim 13, wherein the graph includes concept nodes representing concepts in the content objects, and wherein the focus node is a people node and the query node is a concept node.

18. A system comprising:
a processor;
a networking services module having computer-executable instructions on non-transitory computer-readable medium, the computer-executable instructions when executed by the processor perform steps of:
creatine a graph having a plurality of people nodes representing persons in the organization and a plurality of content nodes representing content objects authored by the persons, the graph having a plurality of edges, including author edges linking the content objects to the persons and similarity edges each linking two content objects and having a similarity value indicative of a similarity between said two content objects;
computing a relevance value between a focus node in the graph and a query node in the graph.

19. A system as in claim 18, further including a storage medium storing data objects representing the graph.

20. A system as in claim 18, wherein the focus node is a first people node representing a first person, and the query node is a second people node representing a second person, wherein computer-executable instructions apply the interest flow analysis along a path in the graph including at least a first content object authored by the first person, a second content object authored by the second person, and a similarity edge linking the first and second content objects.
